(19) United States
(12) Patent Application Publication
(10) Pub. No.: US 2003/0017336 A1
(43) Pub. Date: Jan. 23, 2003

(54) Nanoscale metal particles and method of preparing same

(75) Inventors: Aharon Gedanken, Givataim (IL); Sergei Nikitenko, Moscow Region (RU); Yuri Koltypin, Ashdod (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Bar-Ilan Univeristy

(21) Appl. No.: 09/905,495

(22) Filed: Jul. 16, 2001

(51) Int. Cl. B32B 19/00; B32B 17/02

(52) U.S. Cl. 428/403; 428/328; 423/416; 428/407; 148/105

(57) ABSTRACT

A process of preparing individually-isolated, carbon-coated nanoscale metal particles is disclosed. The process is effected by sonicating a mixture of a metal carbonyl and a hydrocarbon solvent that is selected so as to polymerize during sonication. Air-stable and aqueous solution-stable, carbon-coated nanoscale metal particles and a process of preparing same are also disclosed.

### FIELD AND BACKGROUND OF THE INVENTION

The present invention relates to individually-isolated, carbon-coated, nanoscale metal particles, in particular amorphous metal particles, and to processes of preparing same and, more particularly, to (i) a novel one-step process for preparing individually-isolated, carbon-coated, nanoscale metal particles; and (ii) air-stable and aqueous solution-stable nanoscale metal particles and a process of preparing same.

Nanoscale particles, which are also known and referred to in the art as nanoparticles, are particles having a diameter of less than 100 nm.

The advantageous use of metal nanoparticles is well known in the art. In particular, nanoscale particles of amorphous magnetic metals, preferably carbon-coated particles, are known as useful materials in applications such as magnetic data storage, xerography, magnetic resonance imaging and magnetic inks [1]. Carbon-coated nanoparticles of magnetic metals are highly beneficial since the carbon layer that coats the nanoparticles surface avoids interactions formed between the closely spaced magnetic bits and further provides protection against oxidation of the metal particles [2].

The practical importance of these carbon-coated nanoparticles has motivated many works aimed at the preparation of magnetic nanoparticles encapsulated in carbon, and, in particular, the preparation of carbon-coated iron nanoparticles. The iron nanoparticles are highly beneficial since iron is the ferromagnetic transition metal with the highest magnetic moment. Thus, many different processes have been developed in order to prepare these carbon-coated iron nanoparticles, amongst which are carbon arc [3], flowing gas plasma [4], laser-induced pyrolysis [5-6], mechanosynthesis [7-8] and thermal carbonization [9]. Most of these processes are limited since they yield a mixture of products, such as α—Fe, γ—Fe, Fe₃C, Fe₅C₂, Fe₇C₃ and carbon, that cannot be readily separated. The mechano-chemical processes are advantageous in this respect since they produce a composition of products that is somewhat more uniform. Nevertheless, since these processes require a long-time milling, the particles produced thereby have a broad size distribution, which is contrary to the highly recognized need for a narrower particles size distribution.

A major breakthrough in the production of iron nanoparticles was introduced by Suslick et al. [10, 12] who developed a sonochemical technique that uses the energy of sound (i.e., high-intensity ultrasound) to produce cavitation bubbles in a solvent. The bubble collapse generates an extreme microscale energy release, evidenced by localized transient temperatures of several thousand Kelvin and localized pressures of hundred atmospheres [11-12], which can lead to the homolytic dissociation of molecules that reside within the cavitating bubbles. This technique enables the use of high power ultrasound to perform high-temperature processes at room temperature, using volatile precursors in solutions. The use of ultrasound energy is highly advantageous since ultrasonic equipment is easily accessible, cost efficient and usable on moderately large scale.

Suslick et al. have used this sonochemical technique to decompose Fe(CO)₅ in n-alkanes solutions and thereby produce nano-sized iron particles with a narrow size distribution around 10 nm and large surface areas [10]. However, since the surface of the produced iron nanoparticles is not protected, the nanoparticles prepared by this technique readily oxidize in air and therefore become less effective.

Suslick et al. further used this technique to decompose Fe(CO)₅, as well as other volatile metal carbonyls, in a suspended polymer such as polyvinylpyrollidone, to produce nanoscale metal particles that are isolated by the polymer [10]. Some other amorphous iron-polymer composite materials were recently sonochemically prepared from Fe(CO)₅, using polymers such as polymethylacrylate [14] and poly(dimethylphenylene oxide) [15]. However, this sonolysis process was found to be limited since the produced iron-polymer composites were characterized by a relatively low saturation magnetization (1.5-20 emu/gram at 10 kG), which is attributed to the low iron content therein (about 0.56-10 weight percentages).

The presently known sonochemical procedure for producing carbon-coated nanoscale metal particles are further associated with other limitations.

One common limitation includes, for example, the agglomeration of the produced nanoscale particles, which increases the effective particle size and decreases the particle density, thus making the produced particles less effective. Another limitation, which is briefly discussed hereinabove, concerns the stability of the produced nanoparticles and, more specifically, the oxidation of the nanoparticles which typically occurs during exposure to air or to aqueous solutions and therefore substantially reduces the effectiveness of the nanoparticles in various applications. U.S. Pat. No. 5,766,764 discloses a process where the nanoparticles are formed sonochemically in a mixture of metal carbonyl and an n-alkane solvent, extracted thereafter in an immiscible polar solvent and isolated/coated with a polymer or polymer precursors, so as to form a polymer-metal mixture. The disclosed process therefore provides an isolation of the formed nanoparticles by the polymer, which prevents the agglomeration thereof. However, the process disclosed in U.S. Pat. No. 5,766,764 is a multiple-step process and is therefore complicated and inefficient. Furthermore, the produced nanoparticles are readily oxidizable.

U.S. Pat. No. 5,766,306 discloses a continuous process for the production of individual or agglomerated metal nanoparticles, where a neat metal carbonyl is sonicated to produce the nanoparticles, which are thereafter separated from the precursor by a magnetic separator. A surfactant or dispersant are then added to the separated product to control the agglomeration of the nanoparticles. The disclosed process indeed overcomes the inefficiency limitation. However, the process is still limited by producing nanoparticles that are readily oxidizable and by including an additional separate step to prevent agglomeration. Furthermore, both U.S. Pat. Nos. 5,766,764 and 5,766,306 fail to disclose the iron content within the produced nanoparticles, which evidently effects their efficiency.

Thus, the prior art teaches several techniques for preparing carbon-coated nanoscale metal particles. While most of the presently known techniques provide a mixture of products that are not readily separated and are therefore practically useless, the sonochemical technique provides a highly advantageous option for preparing metal nanoparticles characterized by relatively uniform chemical composition and narrow particles size distribution. Nevertheless, the presently known sonochemical processes for preparing carbon-coated metal nano-particles are also limited as they typically involve the usage of complicated, multi-step processes and produce nanoparticles that are readily oxidizable. The presently known sonochemical processes that involve metal-polymer composites are further limited by the low iron content therein.

There is thus a widely recognized need for, and it would be highly advantageous to have, carbon-coated nanoscale metal particles and novel processes for preparing same devoid of the above limitations.

### SUMMARY OF THE INVENTION

According to the present invention there are provided (i) individually-isolated, carbon-coated, nanoscale metal particles, amorphous magnetic metal particles, in particular; (ii) a novel, advantageous, one-step sonication process of preparing same; (iii) air-stable and aqueous solution-stable carbon-coated nanoscale metal particles; (iv) a novel sonication process of preparing same; (v) carbon-coated nanoscale metal particles that contain at least 70% by weight metal; and (vi) a sonication process for polymerizing a hydrocarbon.

Hence, according to one aspect of the present invention there is provided a process of preparing individually-isolated, carbon-coated nanoscale metal particles, the process comprising sonicating a mixture of a metal carbonyl and a hydrocarbon solvent, wherein the hydrocarbon solvent is selected so as to polymerize during sonication, so as to form a polymerized hydrocarbon.

According to further features in preferred embodiments of the invention described below, sonicating the metal carbonyl generates nanoscale metal particles.

According to still further features in the described preferred embodiments the polymerized hydrocarbon and the nanoscale metal particles co-precipitate so as to form individually-isolated, nanoscale metal particles, carbon-coated by the polymerized hydrocarbon.

According to still further features in the described preferred embodiments the process further comprising separating the individually-isolated, carbon-coated nanoscale metal particles from the mixture.

According to still further features in the described preferred embodiments the process further comprising, prior to the separating, adding a precipitating solvent to the mixture.

According to another aspect of the present invention there are provided individually-isolated, carbon-coated nanoscale metal particles prepared by the process described hereinabove.

According to yet another aspect of the present invention there is provided a composition-of-matter which comprises individually-isolated, carbon-coated nanoscale metal particles, prepared by a process comprising (a) sonicating a mixture of a metal carbonyl and a hydrocarbon solvent, wherein the hydrocarbon solvent is selected so as to polymerize during sonication, so as to form a polymerized hydrocarbon and further wherein the metal carbonyl sonolitically decomposes, so as to form nanoscale metal particles, whereas the polymerized hydrocarbon and the nanoscale metal particles co-precipitate so as to form individually-isolated, nanoscale metal particles, carbon-coated by the polymerized hydrocarbon and (b) separating the nanoscale metal particles from the mixture.

According to further features in preferred embodiments of the invention described below, the process further comprises, prior to (b), adding a precipitating solvent to the mixture.

According to still further features in the described preferred embodiments the metal carbonyl is Fe(CO)₅, and the nanoscale metal particles are superparamagnetic.

According to still another aspect of the present invention there is provided a composition-of-matter which comprises carbon-coated nanoscale metal particles containing at least 70% by weight metal.

According to an additional aspect of the present invention there is provided a process of preparing air-stable, carbon-coated nanoscale metal particles, the process comprising (a) sonicating a mixture of a metal carbonyl and a hydrocarbon solvent, wherein the hydrocarbon solvent is selected so as to polymerize during sonication, so as to form a polymerized hydrocarbon and further wherein the metal carbonyl sonolitically decomposes, so as to form nanoscale metal particles, whereas the polymerized hydrocarbon and the nanoscale metal particles co-precipitate so as to form individually-isolated, nanoscale metal particles, carbon-coated by the polymerized hydrocarbon, (b) separating the nanoscale metal particles from the mixture and (c) annealing the nanoscale metal particles.

According to further features in preferred embodiments of the invention described below, the process further comprises, prior to (b), adding a precipitating solvent to the mixture.

According to still further features in the described preferred embodiments the metal carbonyl is Fe(CO)₅ and the nanoscale metal particles are ferromagnetic.

According to still further features in the described preferred embodiments the annealing in (c) includes heating the nanoscale metal particles at a temperature of at least 400° C.

According to yet an additional aspect of the present invention there are provided air-stable and aqueous solution-stable, carbon-coated nanoscale metal particles prepared by the process described hereinabove.

According to still an additional aspect of the present invention there is provided a process of polymerizing a hydrocarbon, the process comprising sonicating the hydrocarbon.

According to further features in preferred embodiments of the invention described below, the metal carbonyl has a general formula M(CO)ₓ, whereas M is a metal selected from the group consisting of cobalt, chromium, iron, molybdenum and vanadium and x is an integer being compatible with the valency of M.

According to still further features in the described preferred embodiments the metal carbonyl is Fe(CO)₅.

According to still further features in the described preferred embodiments the hydrocarbon has a general formula:

(CHₙ)ₓPh_{y}

wherein,

Ph is a phenyl residue, n is an integer ranging between 0 and 3, inclusive, x is an integer ranging between 1 and 10, inclusive and y is an integer ranging between 1 and 20, inclusive, provided that each (CHₙ) residue comprises at least one phenyl residue.

According to still further features in the described preferred embodiments the hydrocarbon is diphenylmethane.

According to still further features in the described preferred embodiments the precipitating solvent is an n-alkane solvent.

According to still further features in the described preferred embodiments sonicating the mixture or the hydrocarbon is effected at an absorbed acoustic power (P_{ac}) that equals about 0.45 Watt/ml.

According to still further features in the described preferred embodiments sonicating the mixture or the hydrocarbon is effected at 10-30 kHz at 400-800 Watts per 100 ml.

According to a further aspect of the present invention there is provided a composition-of-matter comprising air-stable and aqueous solution-stable, carbon-coated nanoscale metal particles.

According to further features in preferred embodiments of the invention described below, the metal particles are selected from the group consisting of cobalt particles, chromium particles, iron particles, molybdenum particles and vanadium particles.

According to still further features in the described preferred embodiments the nanoscale metal particles include particles selected from the group consisting of metal particles, metal carbide particles, metal oxide particles and a combination thereof.

According to still further features in the described preferred embodiments the nanoscale metal particles have an average particle size ranging between 5 nm and 100 nm, inclusive.

According to still further features in the described preferred embodiments the surfaces of the nanoscale metal particles are covered by a shell, whereas the shell has a thickness ranging between 1 nm and 10 nm, inclusive.

According to still further features in the described preferred embodiments the shell includes carbon and/or metal carbide.

According to still further features in the described preferred embodiments the nanoscale metal particles are stable at ambient atmosphere for at least one month.

According to still further features in the described preferred embodiments the nanoscale metal particles are stable in an aqueous solution for at least one week.

According to still further features in the described preferred embodiments the aqueous solution is selected from the group consisting of water, an alkali aqueous solution and an acidic aqueous solution.

According to still further features in the described preferred embodiments the nanoscale metal particles are nanoscale iron particles.

According to still further features in the described preferred embodiments the nanoscale iron particles include particles selected from the group consisting of α-Fe particles, iron carbide particles, iron oxide particles and a combination thereof.

According to still further features in the described preferred embodiments the iron carbide particles include Fe₃C particles.

According to still further features in the described preferred embodiments the iron oxide particles include Fe₂O₃ particles.

According to still further features in the described preferred embodiments the weight content of the Fe₂O₃ particles ranges between 1 percent and 10 percents.

According to still further features in the described preferred embodiments the nanoscale iron particles have an average particle size ranging between 5 nm and 100 nm, inclusive.

According to still further features in the described preferred embodiments the nanoscale iron particles are ferromagnetic.

According to still further features in the described preferred embodiments the saturation magnetization (Mₛ) value of the nanoscale iron particles ranges between 50 emu per gram and 240 emu per gram.

According to still further features in the described preferred embodiments the coercivity (H_{c}) of the nanoscale iron particles ranges between 5 oersteads and 500 oersteads.

The present invention successfully addresses the shortcomings of the presently known configurations by providing simple and efficient processes of preparing carbon-coated nanoscale metal particles and, in particular, air-stable and aqueous solution-stable carbon-coated nanoscale particles, with high metal content therein, as well as a process of polymerizing hydrocarbons.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-b are low-resolution transmission electron micrographs (TEM) of the DPhM sonication product of the present invention (FIG. 1a), the iron sonication product of Fe(CO)₅ in DPhM solution according to the present invention (FIG. 1b) and the iron sonication product of the present invention annealed at 400° C. (FIG. 1c) and at 700° C. (FIG. 1d);

FIG. 2 is a plot presenting the thermogravimetric (TGA) analysis of the DPhM sonication product of the present invention;

FIG. 3 is a plot presenting the differential scanning calorimetric (DSC) analysis of the DPhM sonication product of the present invention;

FIGS. 4a-b present powder X-ray diffractograms (XRD) of the sonication product of Fe(CO)₅ in DPhM solution (FIG. 4a) according to the present invention, and the annealed product (700° C.) thereof (FIG. 4b);

FIG. 5 is a plot presenting the magnetization of the sonication product of Fe(CO)₅ in DPhM solution according to the present invention;

FIG. 6 presents the Mossbauer spectra (MS) of the annealed product (700° C.) of the present invention; and

FIG. 7 a high-resolution transmission electron micrograph of the annealed product (700° C.) of the present invention.

### DESCRIPTION OF THE PREFERRED EMBODIMENTS

The present invention is of carbon-coated nanoscale metal particles and processes of preparing same. Specifically, the present invention can be used to produce carbon-coated nanoscale metal particles of amorphous metals, nanoscale iron particles in particular, that have high metal content and can be produced as air-stable and aqueous solution-stable nanoscale metal particles. The present invention can be further used to polymerize a hydrocarbon.

The principles and operation of particles and methods of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Most of the presently known processes of preparing carbon-coated nanoscale metal particles involve inefficient multi-steps procedures and typically result in a mixture of products that are not readily separable and/or which are characterized by a broad size distribution, by a low metal content and/or as readily oxidizable particles. In sharp contrast, the present invention provides nanoscale metal particles, nanoscale iron particles in particular, that are characterized by an air-stability, aqueous solution-stability, narrow size distribution and high metal content.

The presently known sonication techniques for producing carbon-coated nanoscale metal particles typically involve sonicating metal carbonyls in n-alkane solutions. Since the radicals formed during the sonication of such solutions are highly unstable, a polymerization reaction of such radicals is unlikely to occur. Therefore, the presently known sonication techniques typically involve the addition of polymers during or after the sonication process, so as to isolate and/or coat the sonolysis nanoparticles. The polymer addition in these processes typically results in low metal/coating ratio of the formed nanoparticles, which detrimentally affect their metal-related properties. Furthermore, the nanoparticles produced by these techniques are characterized by un-coated surfaces and therefore readily oxidize when contacting air.

While reducing the present invention to practice, it was found that sonicating metal carbonyls in a hydrocarbon solvent resulted in co-precipitation of metal nanoparticles and relatively small amounts of polymer-like insoluble products coating the nanoparticles. Analysis of the metal nanoparticles revealed that they are characterized by unpresidently high metal/coating ratio. In further experiments it was uncovered that sonication of the hydrocarbon solvent per se, results in polymerization thereof. It is assumed that hydrocarbons capable of releasing relatively stable free radicals in response to sonication, polymerize upon such release of radicals due to interactions between the radicals and the hydrocarbon from which they were derived. It is further assumed that such polymerization results in the formation of only minute quantities of hydrocarbon polymer which then coprecipitates with the sonolysis metal nanoparticles, resulting in high metal/carbon coating weight ratio. Annealing the coated metal nanoparticles thus produced resulted in metal nanoscale particles highly stable under ambient atmosphere and in aqueous solutions, which are therefore highly advantageous over the far-less stable presently known nanoscale metal particles.

Hence, according to one aspect of the present invention, there is provided a method of preparing individually-isolated, carbon-coated nanoscale metal particles. The process according to this aspect of the present invention is effected by sonicating a mixture of a metal carbonyl and a hydrocarbon solvent that is selected to polymerize during sonicating, so as to form a polymerized hydrocarbon.

The metal carbonyl, according to the present invention, has the general formula M(CO)ₓ, where M is a metal, preferably a transition metal, and x is an integer that is compatible with the valency of the metal M. Metal carbonyls suitable for use in context of the present invention include, for example, and without limitation, Co₂(CO)₈, Cr(CO)₆, Mo(CO)₆, Fe(CO)₅ and V(CO)₅.

According to a preferred embodiment of the present invention, the metal carbonyl is Fe(CO)₅. The use of iron carbonyl as the precursor in the preparation of metal nanoparticles via sonication is highly advantageous since (i) Fe(CO)₅ is a volatile reactant and is therefore suitable for sonication processes; and (ii) iron is the transition metal with the highest magnetic moment and therefore the iron nanoparticles produced by the process of the present invention are highly advantageous materials, for reasons further detailed and discussed in the Background section hereinabove.

As used herein, the term “hydrocarbon” includes an organic compound which comprises hydrogen atoms and carbon atoms that are covalently attached thereamongst.

Thus, the term “hydrocarbon solvent”, as used herein, includes a hydrocarbon as defined hereinabove, which is in liquid state, preferably liquid at room temperature. The hydrocarbon solvent, according to the present invention, is preferably selected such that the metal carbonyl is soluble therein.

The hydrocarbon solvent is selected so as to polymerize during sonication, so as to form a polymerized hydrocarbon. A preferred hydrocarbon solvent according to the present invention includes a hydrocarbon that can generate, during a sonication process, relatively stable radicals within the cavitating bubble that can further react with the hydrocarbon molecules in solution to form a polymer-like insoluble product.

As is well known in the art, stable radicals typically include a group that can stabilize the radical species via an electronic resonance. Stable hydrocarbon radicals therefore typically include, for example, a phenyl or benzyl group.

Thus, according to a preferred embodiment of the present invention, the hydrocarbon solvent has a general formula:

(CHₙ)ₓPh_{y}

where Ph is a phenyl residue, n is an integer ranging between 0 and 3, inclusive, x is an integer ranging between 1 and 10, inclusive, and y is an integer ranging between 1 and 20, inclusive, provided that each (CHₙ) residue comprises at least one phenyl residue. Evidently, the summation of n and the number of the phenyl residues at each (CHₙ) residue equal to 4.

In other words, hydrocarbon solvents suitable for use in the context of the present invention include hydrocarbons, as defined hereinabove, that are composed of an alkylene chain that is substituted by at least one phenyl residue at each carbon in the chain.

The alkylene chain can include, according to the present invention, 1-10 carbon atoms. Preferably it is a low alkylene chain that includes 1-4 carbon atoms. Most preferably, the alkylene chain includes one carbon atom.

Consequently, the alkylene chain can be substituted by, for example, 1-20 phenyl residues, depending on the number of carbon atoms in the alkylene chain.

As used herein, the term “residue” refers to a major portion of a molecule which is covalently linked to another molecule.

Thus, the term “phenyl residue” includes residues such as, but not limited to, —C₆H₅, —C₆H₄— and —C₆H₃—.

The term “(CHₙ)” residue, according to the present invention, thus includes, for example, —CH₂—, —CHPh- and —CPh₂-.

The phenyl (Ph) substitution at each (CHₙ) residue is highly advantageous since the phenyl group stabilizes radicals that are formed either at the phenyl group or at a methylene group (e.g., a substituted or non-substituted carbon) that is linked thereto, via an electronic resonance.

Thus, suitable hydrocarbon solvents that are usable in the context of the present invention include, for example, diphenylmethane (DPhM), triphenylmethane, 1,1,2-triphenylethane, 1,1,2,2-tertaphenylethane and other related polyphenyl-substituted alkanes.

According to a preferred embodiment of the present invention the hydrocarbon solvent is DPhM. DPhM is a relatively volatile hydrocarbon (having a vapor pressure of 1 hPa at 77° C.) that is liquid at room temperature and in which metal carbonyls such as Fe(CO)₅ are highly soluble. These properties render DPhM a highly suitable solvent for the sonication process of the present invention.

As is further detailed in the Examples section that follows, it was experimentally found that sonicating DPhM in liquid state results in the formation of insoluble products, which were characterized as polymer-like solids. Thus, a novel process for polymerizing a hydrocarbon was uncovered. This process is effected by sonicating the hydrocarbon.

According to a preferred embodiment of the present invention, the sonication process of both the hydrocarbon per se and the mixture of the metal carbonyl and the hydrocarbon solvent, is effected at an absorbed acoustic power that ranges between 0.1 Watt/ml and 1 Watt/ml. Preferably, the absorbed acoustic power ranges between 0.3 Watt/ml and 0.6 Watt/ml. More preferably, the absorbed acoustic power ranges between 0.4 Watt/ml and 0.5 Watt/ml. Most preferably, the absorbed acoustic power equals about 0.45 Watt/ml.

According to another preferred embodiment of the present invention, the sonication process is effected at a working frequency that ranges between 10 kHz and 100 kHz, preferably between 10 kHz and 30 kHz and most preferably, the working frequency is of about 20 kHz, at a maximum electric output power that ranges between 200 Watts and 1000 Watts, preferably between 400 Watts and 800 Watts and, most preferably, the maximum electric output power is about 600 Watts, per 100 ml.

As is described hereinabove and is further demonstrated in the Examples section that follows, the sonication process of the present invention results in simultaneous generation of metal nanoparticles and polymerized hydrocarbon in a process which is referred to herein as “sonochemical hydrocarbon polymerization”, resulting in co-precipitation of carbon coated nanoscale metal particles.

According to a preferred embodiment of the present invention, the sonochemical hydrocarbon polymerization results in small amounts of polymerized, insoluble product, which small amount is highly advantageous since it provides for the formation of carbon-coated nanoscale metal particles with a high metal/coating ratio.

Thus, according to another aspect of the present invention, there is provided a composition-of-matter that comprises carbon-coated nanoscale metal particles that contain at least about 70% by weight metal, more preferably at least about 80% by weight metal, where the remaining weight is the polymerized hydrocarbon.

In a representative example, nanoparticles obtained by sonicating a mixture of Fe(CO)₅ in DPhM, include 80% iron particles with a 4:1 ratio between the iron sonication products and the DPhM sonication products. The nanoparticles obtained by this sonication were characterized as superparamagnetic.

Once the sonication process is completed, the formed metal nanoparticles can be separated from the reaction mixture. The separation procedure can include, for example, precipitating the nanoparticles, preferably by the addition of a precipitating solvent to the reaction mixture, such as, but limited to, an n-alkane, e.g., pentane, hexane, heptane and octane, followed by centrifugation. Optionally, when the metal nanoparticles are magnetic, the separation procedure can be effected by magnetically separating the nanoparticles, using a magnetic separator.

The metal nanoparticles obtained by the sonication process of the present invention have a size that ranges between 5 nm and 100 nm, averaging at about 10 nm with a narrow size distribution, where a majority of the particles have a size that ranges between 5 nm and 20 nm.

According to another aspect of the present invention, there is provided a process of preparing air-stable and aqueous solution-stable, carbon-coated nanoscale metal particles. The process is effected by sonicating a mixture of a metal carbonyl and a hydrocarbon solvent as is described hereinabove, separating the individually-isolated, carbon-coated nanoscale metal particles obtained thereby from the mixture and annealing the obtained nanoscale metal particles.

The annealing procedure according to the present invention preferably includes heating the nanoparticles, preferably under an inert argon atmosphere, at a temperature of at least 400° C. Preferably, the annealing procedure is effected at a temperature that ranges between 400° C. and 700° C. Most preferably, the annealing temperature is about 700° C.

As used herein, the term “air-stable and aqueous solution-stable nanoscale metal particles” refers to particles that are stable upon exposure to ambient atmosphere and/or aqueous solutions, as is further detailed hereinbelow. The term “stable”, as used herein, includes, for example, maintaining properties of a material, such as magnetic properties, for a time period of at least a week. Evidently, longer time periods, such as a few months, are advantageous.

As a representative example, nanoscale iron particles obtained by sonicating a mixture of Fe(CO)₅ in DPhM and annealing at 700° C., according to the process of this aspect of the present invention, were tested for air-stability by defining changes in their magnetic properties during continuous exposure to air. The results indicated that the magnetic properties of the annealed iron nanoparticles remained unchanged for at least three months. These iron nanoparticles were further tested for their stability in aqueous solutions, and were found stable for a few weeks in and in an alkaline solution (e.g., 0.1 M NaOH).

The stability of the metal nanoparticles formed by the process of the present invention is attributed to the presence of a shell or coat that continuously covers the surfaces of the nanoparticles, as was determined by the experimental analyses described in the Examples section that follows.

Following annealing, the shell mainly includes carbon and/or metal carbides and has a thickness that ranges between 1 nm and 10 nm. Particularly, the shell's thickness ranges between 3 nm and 7 nm. More particularly, the shell has a thickness of about 5 nm.

The annealed nanoparticles of the present invention have an average size that ranges between 1 nm and 100 nm. Particularly, the particles average size ranges between 20 nm and 70 nm. More particularly, the particles average size ranges between 20 nm and 50 nm, which is considered by those skilled in the art as a narrow size distribution.

The annealed nanoparticles of the present invention include a mixture of particles such as, but not limited to, metal particles, metal carbide particles, metal oxide particles and combinations thereof. The content of the metal oxide particles in the annealed preparation of the present invention is typically low (e.g., between 1% and 10%) and therefore does not noticeably affect the metal-related properties thereof.

The annealed nanoscale metal particles of the present invention are characterized, in addition to their air-stability and aqueous solution-stability, by high metal content and therefore exert high level of metal-related properties, depending on the type of metal employed.

In a representative example, annealed nanoscale iron particles prepared as described hereinabove, were found to be ferromagnetic, with a saturation magnetization value that ranges between 50 emu/gram and 240 emu/gram, depending on the annealing temperature. Thus, a saturation magnetization value of 212 emu/gram was determined for iron nanoparticles that were annealed at 700° C. This value nearly equals the saturation magnetization value of a commercial iron powder (220 emu/gram), which value exemplifies the high metal-related property of the carbon-coated nanoparticles of the present invention.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Materials and Methods

Diphenylmethane (DPhM) (>99%, Fluka) and Fe(CO)₅ (99.5%, Strem Chemicals) were used without additional purification.

Sonication was performed in a 100-ml spherical glass reactor, using “Sonics and Materials” ultrasonic device (at working frequency of 20 kHz and maximum electric output power of 600 Watts), equipped with a titanium horn (irradiative surface area 1 cm²) which was immersed reproducibly below the surface of the sonicated liquid. The sonicated solutions were bubbled with an argon flow of 100 ml/minute for 15 minutes before the sonication process and were further bubbled during sonication. The absorbed acoustic power, P_{ac}, measured by the thermal probe method [11] was found to be equal to 0.45 Watt/ml. The macroscopic temperature during sonication was kept at 30° C. using an acetone bath and a “Julabo FT901” cooler.

The solid products obtained by the sonication process were removed from the solution by centrifugation at 9000 rev/minute and were washed three times with pentane. The obtained solid products were then dried under vacuum and kept in an inert glove box (<5 ppm O₂).

Annealing of materials was performed in a tube furnace under argon flow (containing about 2 ppm O₂).

Powder X-ray diffractograms (XRD) were recorded on Rigaku X-ray instrument (Cu—K_{α} radiation, λ=0. 15418 nm).

Low-resolution transmission electron micrographs (TEM) were obtained using a JEOL-JEM100SX electron microscope.

High-resolution TEM were measured by High resolution TEM images were obtained by employing a JEOL-3010 with 300 kV accelerating voltage. Samples for TEM were prepared by placing a drop of the sample suspension on a copper grid coated with a carbon film and were allowed to dry in air.

X-ray photoelectron spectroscopy (XPS) was measured using an AXIS, HIS 160, ULTRA apparatus.

Thermogravimetric analysis (TGA) and differential scanning calorimetric (DSC) analysis were performed using a Mettler Toledo TGA/SDTA851 device in a temperature range of between 30° C. and 900° C., at a heating rate of 10° C./minute, under nitrogen atmosphere.

Magnetization loops were measured using a Quantum Design MPMS SQUID magnetometer.

Mossbauer spectra (MS) were measured using a conventional constant acceleration spectrometer with a 50 mCi ⁵⁷Co(Rh) source.

FT-IR spectra were recorded in KBr pellets using Impact 410 Nicolet spectrometer.

Elemental analysis was carried out using an Eager 200 CHN analyzer.

### Experimental Results

Sonication of pure diphenylmethane: A solution of pure DPhM was sonicated, using the sonication procedure described hereinabove, for 3 hours, during which the color of the DPhM solution turned from light yellow to deep brown. An equal volume of pentane was then added to the sonicated solution and the solid product obtained was removed by centrifugation, as described hereinabove. The obtained DPhM sonication product was an almost black solid, and was found stable in air at room temperature. The DPhM sonication product was found insoluble in acetone, benzene, pentane, and alcohol and slightly soluble in dimethylsulfoxide.

The elemental analyses of the pure, unreacted DPhM and the solid sonication product obtained therefrom are presented in Table 1 below. The data show that the sonication product is enriched with carbon as compared with pure DPhM.

TABLE 1

| | Carbon | Hydrogen | |
|---|---|---|---|
| Product | (weight %) | (weight %) | Carbon/Hydrogen |
| Pure DPhM | calculated: 92.9 | 7.1 | 13.1 |
| | found: 92.5 | 7.5 | 12.3 |
| Sonication | 94.2 | 5.8 | 16.2 |
| product | | | |

Spectral Analyses of DPhM Sonication Product:

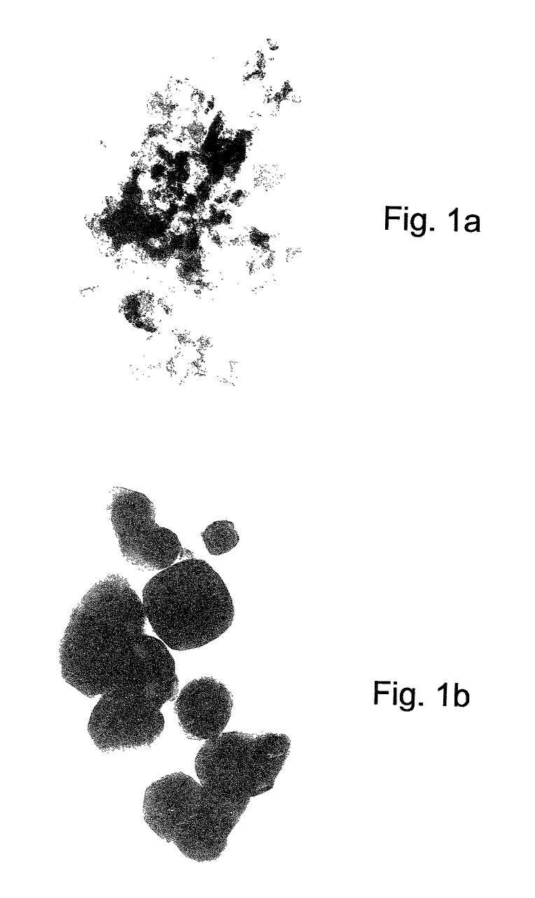

The low-resolution TEM of the DPhM sonication product is presented in FIG. 1a. The obtained micrograph indicates that the product consists of plate-shaped particles, having an average size of about 5-10 nm. The product is X-ray amorphous.

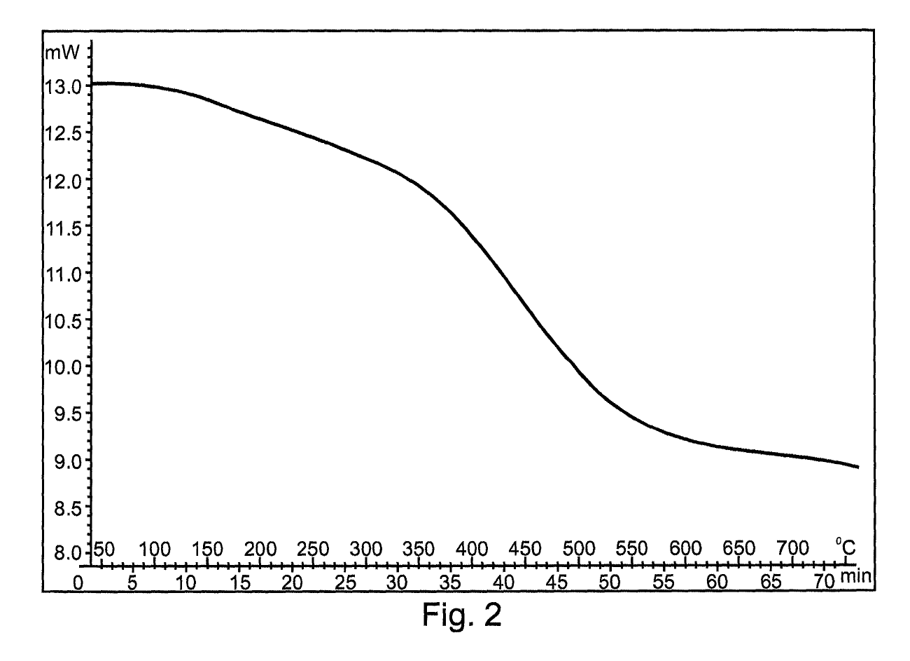

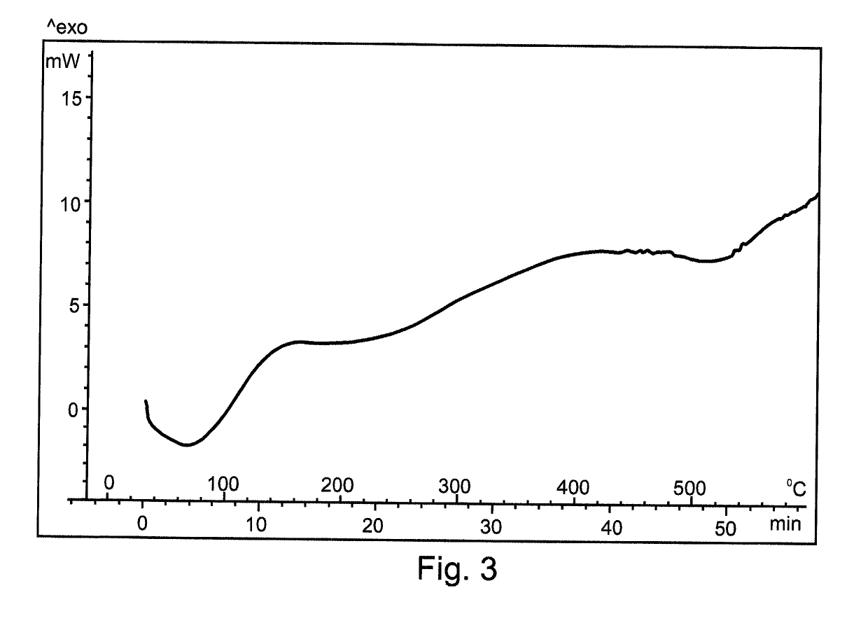

FIGS. 2 and 3 present the TGA and DSC curves, respectively, of the DPhM sonication product. The TGA curve demonstrates a mass lost of an about 29% in a temperature range of between 150° C. and 600° C. The DSC curve includes two broad endothermal peaks centered around 240° C. and 520° C. This thermal behavior is known as a typical behavior of polymers that have polydispersed chain size [16].

Table 2 below presents the observed frequencies and probable assignments of DPhM and the sonication product thereof, obtained by IR measurements. The analysis and assignments of the FT-IR spectra was performed according to published data [17].

TABLE 2

| pure DPhM | Sonication product | Assignment |
|---|---|---|
| 3026-3060 | 3020-3060 | ν(C—H) |
| medium | medium | aromatic |
| 2838-2905 | 2851-2912 | ν(C—H) |
| medium | medium | aliphatic |
| 1602 medium | not observed | shape typical for |
| 1803, 1944 weak | | mono-substituted |
| | | phenyls |
| 1452-1602 | 1447-1595 | ν(C=C) |
| medium | medium | aromatic |
| not observed | 809 | ν(C—H) |
| | weak | aromatic for |
| | | p-substituted phenyls |
| 696 strong | 702 | ν(C—H) |
| 735 strong | weak | aromatic for |
| | | mono-substituted |
| | | phenyls |

The observed differences between the FT-IR spectra of the initial DPhM and the sonication product indicate that there have been considerable modifications in the material structure as a result of the sonication process. For example, the FT-IR spectrum of the sonication product does not include, or includes with a considerable decrease of intensity, bands corresponding to mono-substituted phenyls (e.g., 696, 1602, 1803, 1944 and 735 cm⁻¹), which are present in the FT-IR spectrum of the initial DPhM. These results may indicate that an H-substitution at the aromatic ring occurred during the formation of the DPhM sonication product. The appearance of a new band at 809 cm⁻¹, in the FT-IR spectrum of the DPhM sonication product can be attributed to the formation of p-substituted phenyls during the sonication process.

Proposed Mechanism of the Formation of DPhM Sonication Products:

The data obtained by the spectral and elemental analyses described hereinabove indicate that during sonication of liquid DPhM a mixture of polyphenyl compounds that have an irregular structure are formed. Presumably, the products mixture is formed as a result of a dissociation of the DPhM molecules within the cavitating bubble, which is followed by scavenging the sonochemically formed radicals by the DPhM molecules that are present in the solution after bubble collapse. The products formation can further involve radical recombination mechanisms.

However, since the radicals' concentration in the sonicated solution is significantly lower than the concentration of DPhM, the radical recombination option is thought to be less probable.

Hence, and without limitation, a proposed mechanism of the formation of DPhM sonication products, is represented in Scheme I below. The proposed mechanism is represented by way of example only and the invention is by no means limited to this mechanism.

### Scheme I

(a) Radicals formation in the cavitating bubble:

C₆H₅CH₂C₆H₅—)))C₆H₅CH.C₆H₅+H. (1)

C₆H₅CH₂C₆H₅—)))C₆H₅.+.CH₂C₆H₅ (2)

C₆H₅CH₂C₆H₅—)))C₆H₅CH₂C₆H₄.+H. (3)

(b) Radicals scavenging by DPhM in solution

C₆H₅CH₂C₆H₅+C₆H₅.→C₆H₅CH(C₆H₅)C₆H₅+H. (4)

C₆H₅CH(C₆H₅)C₆H₅+C₆H₅.→C₆H₅CH(C₆H₅)C₆H₄C₆H₅+H. (5)

C₆H₅CH(C₆H₅)C₆H₄C₆H₅+C₆H₅.→C₆H₅CH(C₆H₅)C₆H₄C₆H₄C₆H₅+H. (6)

(c) Radical recombination in solution:

2H.→H₂ (7)

2C₆H₅.→C₆H₅—C₆H₅ (8)

2C₆H₅CH₂.→C₆H₅CH₂—CH₂C₆H₅ (9)

2C₆H₅CH₂C₆H₄.→C₆H₅CH₂C₆H₄—C₆H₄CH₂C₆H₅ (10)

2C₆H₅CH.C₆H₅→C₆H₅(C₆H₅)CH—CH(C₆H₅)C₆H₅ (11)

The symbol —))) corresponds to a sonochemical process, and equations 1-3 presents the radicals formed thereby. A formation of biradicals, such as CH₂.. and C₆H₅CH.., during the sonochemical process is less probable and is therefore not included in the reaction scheme.

Once the radicals are formed and the bubble collapse, they interact, via radical substitution, with the DPhM molecules in solution. The radical substitution occurs at the methylene-group position or at the phenyl p-position of the DPhM. Equations 4-6 represents only the scavenging of a C₆H₅. radical in order to simplify the reaction scheme. Evidently, other radicals, such as the radicals formed according to equations 2-3 are scavenged by DPhM.

The radicals formed by the sonochemical process may further interact therebetween, so as to form radical recombination. Nevertheless, as is mentioned hereinabove, these interactions are not likely to occur. The radical recombination can be symmetric, as is described in equations 7-11 hereinabove, or asymmetric.

All of the products formed in the equations 4-6 and 8-11 can further react with the radicals formed within the cavitating bubble (equations 1-3), so as to form more complex compounds. It is therefore assumed that the sonication of DPhM results in the formation of a mixture of products that are structurally related to a low-chain polyphenylpolymethylene polymer and are hence referred herein as “polymer-like” products.

Sonication of Fe(CO)₅ in DPhM Solutions:

A solution of 3.3 ml Fe(CO)₅ (4.9 grams, 25 mmol) and 96.7 ml DPhM was prepared and subjected to the sonication process described hereinabove. The yellow transparent reactants solution changed its color rapidly to black during the sonication process. After 3 hours of sonication, the solution was transferred, under argon atmosphere, into an inert glove-box. Fifty ml of pentane were then added to the sonicated solution and a black precipitate was obtained. The precipitate was washed three times with pentane and thereafter dried under reduced pressure. 0.930 gram of a solid dark product was obtained. The elemental analysis data of the obtained solid, presented in Table 3 below, indicate that the sonication product contains about 80% iron, which corresponds to a reaction yield of 53% from the theoretical yield with respect to iron.

TABLE 3

| | Carbon | Hydrogen | |
|---|---|---|---|
| Product | (weight %) | (weight %) | Carbon/Hydrogen |
| Sonication product | 17.6 | 1.5 | 11.7 |
| annealed at 400° C. | 6.1 | 0.17 | 35.9 |
| during 3 h | | | |
| annealed at 700° C. | 5.6 | 0.08 | 70 |
| during 3 h | | | |
| annealed at 850° C. | 2.9 | 0 | 70 |
| during 3 h | | | |

The elemental analysis data of the sonication product further show that it contains about 20% of DPhM sonication products. The carbon/hydrogen ratio in the sonication product was found to be close to the ratio obtained in the sonication products of pure DPhM.

Spectral Analyses of Sonication Products of Fe(CO)₅ in DPhM Solutions:

The FT-IR spectrum of the sonication solid product includes absorption bands at 3060-3020 cm⁻¹ and 2900-2850 cm⁻¹, which are assigned to C—H stretch vibrations in aromatic and aliphatic groups, respectively, and are also included in the FT-IR spectrum of pure DPhM sonication product.

The FT-IR spectrum of the sonicated deep green solution remained after the solid product removal, exhibits absorption bands at 2010-2050 cm⁻¹ and 1830-1870 cm⁻¹, which are typical for C—O stretch vibrations of terminal and bridging carbonyl groups, respectively, in a Fe₃(CO)₁₂ complex [18].

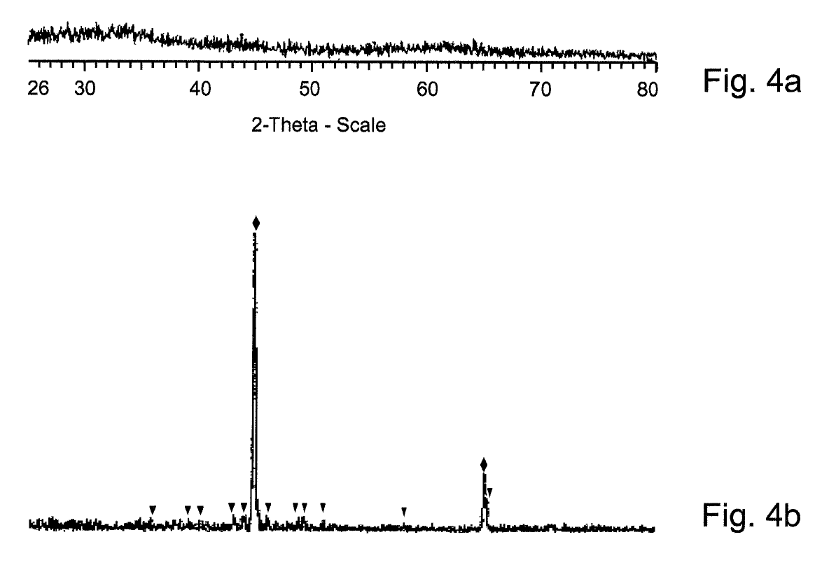

As shown in FIG. 4a, the XRD diagram of the sonication product indicates that the product is X-ray amorphous.

The low-resolution TEM image of the sonication product is presented in FIG. 1b and shows that the product consists of small globular agglomerates having a diameter of about 10 nm, and very small and highly electron dense particles, having a diameter of about 1 nm, dispersed inside the globules. These results suggest that the very small particles are iron nanoparticles formed from Fe(CO)₅, and encapsulated in globules of the DPhM sonication products.

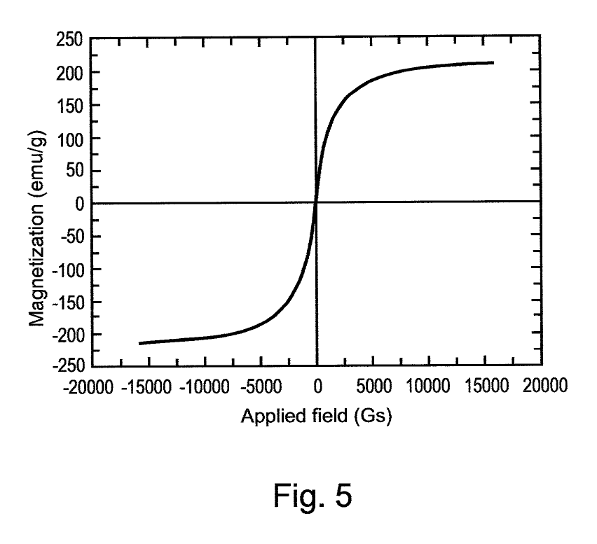

The magnetic curve of the sonication product is presented in FIG. 5. The product was found to be superparamagnetic, which is a magnetic property attributed to iron particles size of less than 10 nm, according to a recently published data [10]. This observation confirms the presence of small iron nanoparticles having a diameter of about 1 nm within the sonication product, as was suggested according to the low-resolution TEM data obtained.

The TGA analysis of the iron sonication product resulted in a curve that exhibits a two-stage mass lost: about 12.5% at 150-230° C. and about 5.3% at 320-350° C. The DSC analysis performed for the iron product resulted in a curve that includes several broad endothermal peaks ranging between 150° C. and 360° C. and a sharp exothermal peak centered at 480° C. The endothermal effects and the observed mass lost are related to degradation of the DPhM sonication products during heating. The exothermal peak typically corresponds to iron crystallization. This high iron crystallization temperature (about 480° C.) in DPhM solutions is much higher than the iron crystallization temperature obtained in alkane solutions (about 320° C.) [19-20], and can be attributed to the presence of DPhM sonication products that act as an organic matrix which avoids agglomeration of the iron nanoparticles.

Proposed Mechanism for the Formation of Sonication Products of Fe(CO)₅ in DPhM:

The data collected while reducing the present invention to practice indicate that the sonication of Fe(CO)₅ in DPhM solvent involves two reactions, which are represented in Scheme II below, as a non-limiting example.

### Scheme II

Fe(CO)₅—))) Fe+5CO (major process) (12)

4Fe(CO)₅—))) Fe+Fe₃(CO)₁₂+8CO (secondary process) (13)

The major process results in the formation of Fe nanoparticles, while the secondary process results in the formation of the oxidation product Fe₃(CO)₁₂. The oxidation product formation was also observed during sonication of Fe(CO)₅ in alkane solutions [19], and it is therefore assumed that the sonication process of Fe(CO)₅ occurs via similar mechanism when performed in alkane solutions and in DPhM solution. Thus, in accordance with the two-site model of the sonochemical processes in alkane solutions [12], it is assumed that reaction (12) occurs inside the cavitating bubble at high local temperatures, while reaction (13) occurs at milder conditions within the liquid shell that surrounds the cavitating bubble.

Annealing of the Sonication Product of Fe(CO)₅ in DPhM:

Annealing of the obtained sonication products of Fe(CO)₅ in DPhM solution was performed, as described hereinabove, by heating a sample under argon atmosphere for 3 hours at 400° C., 750° C. or 800° C., and resulted in air-stable magnetic products. The color of the annealed samples was changed from black at 400° C. to dark gray at 850° C.

The elemental analyses data obtained for the annealed products, as is presented in Table 3 hereinabove, indicate that the annealing process caused considerable decrease of the carbon and hydrogen contents in the solid samples.

Spectral Analyses of the Annealing Products:

The low resolution TEM images, as is presented in FIGS. 1c and 1d, show that the annealed material consists of round-shaped nanoparticles having a relatively narrow particle size distribution ranging between 20 nm and 50 nm. Increasing the annealing temperature from 400° C. to 700° C. did not affect the obtained particles size.

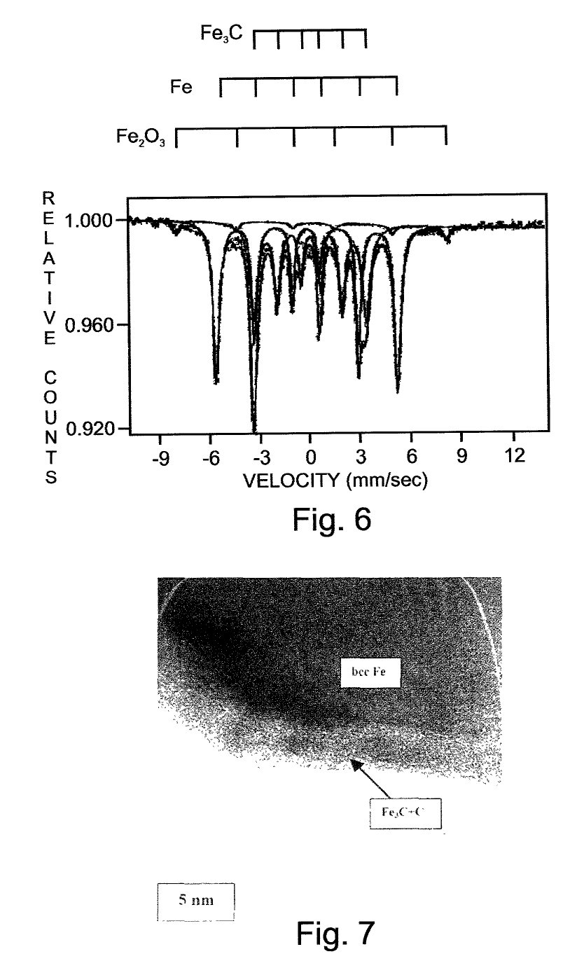

MS measurements and XRD patterns of the product annealed at 700° C. are presented in FIG. 6 and FIG. 4b, respectively. The data obtained by these measurements for the various annealed samples show that the annealed samples contain α—Fe, iron carbide Fe₃C and small amounts of Fe₂O₃. According to the MS data, the Fe₂O₃ content is less than 6% and therefore can not be detected by XRD. The data further show that increasing the annealing temperature leads to a decrease of the Fe₃C contents in the annealed samples.

Table 4 below presents the data obtained by XPS measurements. The surface carbon concentration was found to be much higher than the average carbon concentration obtained in the elemental analysis. This observation indicates that a carbon shell is formed on the iron particles surface during the process. Etching the surface of the particles with argon plasma during about 12 minutes caused a decrease of carbon concentration and an increase of iron concentration. Further etching did not cause significant change. Since a 12 minutes etching corresponds to a sputtered shell width of about 5 nm at the applied sputtering conditions, it is estimated that a carbon shell having thickness of about 5 nm is formed at the iron particles surface during the annealing process and thereby produces air-stable products which do not readily oxidized, as is further detailed hereinbelow.

TABLE 4

| | Etching time | Surface concentration, (mass %) | | |
|---|---|---|---|---|
| Sample | (minutes) | Fe | C | O |
| Annealed at | 0 | 41.49 | 41.66 | 16.85 |
| 400° C. | 12 | 68.48 | 21.45 | 10.12 |
| | 24 | 70.69 | 20.51 | 8.80 |
| Annealed at | 0 | 39.15 | 46.06 | 14.78 |
| 700° C. | | | | |

This core-shell structure of the obtained nanoparticles is further confirmed by the high-resolution TEM measurements, as shown in FIG. 7.

Table 5 below presents the saturation magnetization (Mₛ) and coercivity (H_{c}) of the annealed samples as a function of the annealing temperature. It is shown that the annealed products are ferromagnetic, as opposed to the superparamagnetic sonication product. It is further shown that increasing the annealing temperature causes an increase of the Mₛ value and a decrease of the coercive force. The Mₛ value obtained for the sample annealed at 700° C. almost equals the Mₛ value of pure iron powder.

TABLE 5

| Sample | Mₛ* (emu/gram) | H_{c} (oersteads) |
|---|---|---|
| Annealed at 300° C. | 96 | 480 |
| Annealed at 400° C. | 155 | 170 |
| Annealed at 700° C. | 212 | 40 |
| Commercial Fe powder | 220 | 10 |
| (<5 μm) | | |

*At the field of 15 kGs.

The magnetic properties of the nanocrystalline sonication product annealed at 700° C. remained unchanged during contact with air for at least 2 months. The product was also stable in water or 0.1M NaOH solution for several weeks. A very slow dissolution of the material was observed in 0.1M HCl solutions. The products annealed at lower temperatures were found to be less stable. The sample annealed at 400° C. was partially oxidized during 2 months storage in air, and oxidized within a few days in aqueous solutions.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

### REFERENCES CITED

### Additional References are Cited in the Text

1. Harris Peter J. F. Carbon nanotubes and related structures, Cambridge University Press, 1999, p.164.

2. Jiao J., Seraphin S., Wang X. And Withers J. C. Preparation and properties of ferromagnetic carbon-coated Fe, Co and Ni, J. Appl. Phys., 1996, v.80, p. 103.

3. McHenry M. E., Majetich S. A. and Kirpatrick E. M. Synthesis, structure, properties and magnetic applications of carbon-coated nanocrystals produced by carbon arc. Materials science and engineering A—microstructure and processing, 1995, v.204, N1-2, 19-24 Dec.

4. Iwama S., Fukaya T., Tanaka K., Ohshita K. and Sakai Y. Nanocomposite Powders of Fe—C system produced by the flowing gas plasma processing, Nanostructured Materials, 1999, v.12, p.241.

5. Gunguly B., Huffman G. P., Huggins F. E., Endo M. and Eklund P. C. Nanocrystalline α—Fe, Fe₃C and Fe₇C₃ produced by CO₂-laser Pyrolysis, Journal of Materials Research, 1993, v.8, N7, p.1666.

6. Zhao X. Q., Liang Y., Hu Z. Q. and Liu B. X. Oxidation characteristics and magnetic properties of iron carbide and iron ultrafine particles, J. Appl. Phys., 1996, v.80, N10, p.5857.

7. Goodwin T. J., Yoo S. H., Matteazzi P. and Groza J. R. Cementite-iron nanocomposite, Nanostructured Materials, 1997, v.8, N5, p.559.

8. Yelsukov E. P., Lomayeva S. F., Konygin G. N., Dorofeev G. A., Povstugar V. I., Mikhailova S. S., Zagainov A. V. and Kadikova A. H. Structure, phase composition and magnetic characteristics of the nanocrystalline iron obtained by mechanical milling in heptane, Nanostructured Materials, 1999, v.12, N 1-4, Part A, Sp.Iss., p.483.

9. Hirano S. and Tajima S. J. Mat. Sci., 1990, v.25, p.4457.

10. Suslick K. S., Fang M. and Hyeon T. Sonochemical synthesis of iron colloids, J. Am. Chem. Soc., 1996, v.118, p. 11960.

11. Mason T. J. Chemistry with ultrasound, 1990, Elsevier, Oxford.

12. Suslick K. S. Sonochemistry, Kirk-Othmer Encyclopedia of Chemical Technology, Fourth Edition, Supplement, John Wiley & Sons, 1998.

13. Beilstein 5, 588, I 277.

14. Wizel S., Prosorov R., Cohen Y., Aurbach D., Margel S. and Gedanken A. The preparation of metal-polymer composite materials using ultrasound radiation, J. Mater. Res., 1998, V.13, N1, p.211.

15. De Caro D., Ely T. O., Mari A. and Chaudet B. Synthesis, Characterization and Magnetic Studies of Nonagglomerated Zerovalent Iron Particles. Unexpected Size Dependence of the Structure, Chem. Mater., 1996, v.8, p.1987.

16. Van Krevelen D. W. Properties of Polymers, Elsevier, Amsterdam, 1976. 17. Nakanishi K. and Solomon P. H. Infrared absorption spectroscopy, 1982, Holden-Day Inc., San Francisco.

18. Braterman P. S. Metal carbonyl spectra, Academic Press, New York, 1975.

19. Suslick K. S., Choe S. B., Cichowlas A. and Grinstaff M., Nature, 1991, v.353, p.414.

20. Cao X., Koltypin Yu., Kataby G., Prozorov R. and Gedanken A. Controlling the particle size of amorphous iron nanoparticles, J. Mater. Res., 1995, vol. 10, NI 1, p.2952.

What is claimed is:

1. A process of preparing individually-isolated, carbon-coated nanoscale metal particles, the process comprising sonicating a mixture of a metal carbonyl and a hydrocarbon solvent, wherein said hydrocarbon solvent is selected so as to polymerize during sonication, so as to form a polymerized hydrocarbon.

2. The process of claim 1, wherein sonicating said metal carbonyl generates nanoscale metal particles.

3. The process of claim 2, wherein said polymerized hydrocarbon and said nanoscale metal particles co-precipitate so as to form individually-isolated, nanoscale metal particles, carbon-coated by said polymerized hydrocarbon.

4. The process of claim 1, wherein said metal carbonyl has a general formula M(CO)ₓ, whereas M is a metal selected from the group consisting of cobalt, chromium, iron, molybdenum and vanadium and x is an integer being compatible with the valency of M.

5. The process of claim 1, wherein said metal carbonyl is Fe(CO)₅.

6. The process of claim 1, wherein said hydrocarbon solvent has a general formula:
(CHₙ)ₓPh_{y}
wherein,
Ph is a phenyl residue;
n is an integer ranging between 0 and 3, inclusive;
x is an integer ranging between 1 and 10, inclusive; and
y is an integer ranging between 1 and 20, inclusive;
provided that each (CHₙ) residue comprises at least one phenyl residue.

7. The process of claim 6, wherein said hydrocarbon solvent is diphenylmethane.

8. The process of claim 1, wherein said nanoscale metal particles have an average particle size ranging between 5 nm and 100 nm, inclusive.

9. The process of claim 5, wherein said nanoscale metal particles are superparamagnetic.

10. The process of claim 1, wherein sonicating said mixture is effected at an absorbed acoustic power (P_{ac}) that equals about 0.45 Watt/ml.

11. The process of claim 1, wherein sonicating said mixture is effected at 10-30 kHz at 400-800 Watts per 100 ml.

12. The process of claim 1, further comprising separating said individually-isolated, carbon-coated nanoscale metal particles from said mixture.

13. The process of claim 12, further comprising, prior to said separating, adding a precipitating solvent to said mixture.

14. The process of claim 13, wherein said precipitating solvent is an n-alkane solvent.

15. Individually-isolated, carbon-coated nanoscale metal particles prepared by the process of claim 1.

16. A composition-of-matter which comprises individually-isolated, carbon-coated nanoscale metal particles, prepared by a process comprising:
(a) sonicating a mixture of a metal carbonyl and a hydrocarbon solvent, wherein said hydrocarbon solvent is selected so as to polymerize during sonication, so as to form a polymerized hydrocarbon and further wherein said metal carbonyl sonolitically decomposes, so as to form nanoscale metal particles, whereas said polymerized hydrocarbon and said nanoscale metal particles co-precipitate so as to form individually-isolated, nanoscale metal particles, carbon-coated by said polymerized hydrocarbon; and
(b) separating said nanoscale metal particles from said mixture.

17. The composition-of-matter of claim 16, wherein said process further comprises, prior to (b):
(c) adding a precipitating solvent to said mixture.

18. The composition-of-matter of claim 17, wherein said precipitating solvent is an n-alkane solvent.

19. The composition-of-matter of claim 16, wherein said metal carbonyl has a general formula M(CO)ₓ, whereas M is a metal selected from the group consisting of cobalt, chromium, iron, molybdenum and vanadium and x is an integer being compatible with the valency of the M.

20. The composition-of-matter of claim 16, wherein said metal carbonyl is Fe(CO)₅.

21. The composition-of-matter of claim 16, wherein said hydrocarbon solvent has a general formula:
(CHₙ)ₓPh_{y}
wherein,
Ph is a phenyl residue;
n is an integer ranging between 0 and 3, inclusive;
x is an integer ranging between 1 and 10, inclusive; and
y is an integer ranging between 1 and 20, inclusive;
provided that each (CHₙ) residue comprises at least one phenyl residue.

22. The composition-of-matter of claim 21, wherein said hydrocarbon solvent is diphenylmethane.

23. The composition-of-matter of claim 16, wherein said nanoscale metal particles have an average particle size ranging between 5 nm and 100 nm, inclusive.

24. The composition-of-matter of claim 20, wherein said nanoscale metal particles are superparamagnetic.

25. A process of preparing air-stable, carbon-coated nanoscale metal particles, the process comprising:
(a) sonicating a mixture of a metal carbonyl and a hydrocarbon solvent, wherein said hydrocarbon solvent is selected so as to polymerize during sonication, so as to form a polymerized hydrocarbon and further wherein said metal carbonyl sonolitically decomposes, so as to form nanoscale metal particles, whereas said polymerized hydrocarbon and said nanoscale metal particles co-precipitate so as to form individually-isolated, nanoscale metal particles, carbon-coated by said polymerized hydrocarbon;
(b) separating said nanoscale metal particles from said mixture; and
(c) annealing said nanoscale metal particles.

26. The process of claim 25, wherein said metal carbonyl has a general formula M(CO)ₓ, whereas M is a metal selected from the group consisting of cobalt, chromium, iron, molybdenum and vanadium and x is an integer being compatible with the valency of M.

27. The process of claim 25, wherein said metal carbonyl is Fe(CO)₅.

28. The process of claim 25, wherein said hydrocarbon solvent has a general formula:
(CHₙ)ₓPh_{y}
wherein,
Ph is a phenyl residue;
n is an integer ranging between 0 and 3, inclusive;
x is an integer ranging between 1 and 10, inclusive; and
y is an integer ranging between 1 and 20, inclusive;
provided that each (CHₙ) residue comprises at least one phenyl residue.

29. The process of claim 28, wherein said hydrocarbon solvent is diphenylmethane.

30. The process of claim 25, wherein said nanoscale metal particles have an average particle size ranging between 5 nm and 100 nm, inclusive.

31. The process of claim 25, wherein sonicating said mixture is effected at an absorbed acoustic power (P_{ac}) that equals about 0.45 Watt/ml.

32. The process of claim 25, wherein sonicating said mixture is effected at 10-30 kHz at 400-800 Watts per 100 ml.

33. The process of claim 25, further comprising, prior to (b);
(d) adding a precipitating solvent to said mixture.

34. The process of claim 33, wherein said precipitating solvent is an n-alkane solvent.

35. The process of claim 27, wherein said nanoscale metal particles are ferromagnetic.

36. The process of claim 25, wherein said annealing in (c) includes heating said nanoscale metal particles at a temperature of at least 400° C.

37. Air-stable and aqueous solution-stable, carbon-coated nanoscale metal particles prepared by the process of claim 25.

38. A composition-of-matter comprising air-stable and aqueous solution-stable, carbon-coated nanoscale metal particles.

39. The composition-of-matter of claim 38, wherein said metal particles are selected from the group consisting of cobalt particles, chromium particles, iron particles, molybdenum particles and vanadium particles.

40. The composition-of-matter of claim 38, wherein said nanoscale metal particles are nanoscale iron particles.

41. The composition-of-matter of claim 38, wherein said nanoscale metal particles include particles selected from the group consisting of metal particles, metal carbide particles, metal oxide particles and a combination thereof.

42. The composition-of-matter of claim 38, wherein said nanoscale metal particles have an average particle size ranging between 5 nm and 100 nm, inclusive.

43. The composition-of-matter of claim 38, wherein the surfaces of said nanoscale metal particles are covered by a shell, whereas said shell has a thickness ranging between 1 nm and 10 nm, inclusive.

44. The composition-of-matter of claim 43, wherein said shell includes carbon and/or metal carbide.

45. The composition-of-matter of claim 40, wherein said nanoscale iron particles include particles selected from the group consisting of α-Fe particles, iron carbide particles, iron oxide particles and a combination thereof.

46. The composition-of-matter of claim 45, wherein said iron carbide particles include Fe₃C particles.

47. The composition-of-matter of claim 46, wherein said iron oxide particles include Fe₂O₃ particles.

48. The composition-of-matter of claim 47, wherein the weight content of said Fe₂O₃ particles ranges between 1 percent and 10 percents.

49. The composition-of-matter of claim 40, wherein said nanoscale iron particles have an average particle size ranging between 5 nm and 100 nm, inclusive.

50. The composition-of-matter of claim 40, wherein said nanoscale iron particles are ferromagnetic.

51. The composition-of-matter of claim 40, wherein the saturation magnetization (Mₛ) value of said nanoscale iron particles ranges between 50 emu per gram and 240 emu per gram.

52. The composition-of-matter of claim 40, wherein the coercivity (H_{c}) of said nanoscale iron particles ranges between 5 oersteads and 500 oersteads.

53. The composition-of-matter of claim 38, wherein said nanoscale metal particles are stable at ambient atmosphere for at least one month.

54. The composition-of-matter of claim 38, wherein said nanoscale metal particles are stable in an aqueous solution for at least one week.

55. The composition-of-matter of claim 54, wherein said aqueous solution is selected from the group consisting of water, an alkali aqueous solution and an acidic aqueous solution.

56. A process of polymerizing a hydrocarbon, the process comprising sonicating said hydrocarbon.

57. The process of claim 56, wherein said hydrocarbon has a general formula:
(CHₙ)ₓPh_{y}
wherein,
Ph is a phenyl residue;
n is an integer ranging between 0 and 3, inclusive;
x is an integer ranging between 1 and 10, inclusive; and
y is an integer ranging between 1 and 20, inclusive;
provided that each (CHₙ) residue comprises at least one phenyl residue.

58. The process of claim 57, wherein said hydrocarbon is diphenylmethane.

59. The process of claim 56, wherein sonicating said hydrocarbon is effected at an absorbed acoustic power (P_{ac}) that equals about 0.45 Watt/ml.

60. The process of claim 56, wherein sonicating said hydrocarbon is effected at 10-30 kHz at 400-800 Watts per 100 ml.

61. A composition-of-matter comprising carbon-coated nanoscale metal particles containing at least 70% by weight metal.
